(19) United States
(12) Patent Application Publication
(10) Pub. No.: US 2002/0076139 A1
(43) Pub. Date: Jun. 20, 2002

(54) MEMS optical switch with acoustic pulse actuation

(76) Inventor: Boris Kobrin, San Francisco, CA (US)

Correspondence Address: JOSHUA D. ISENBERG, 204 CASTRO LANE, FREMONT, CA, 94539, US

(21) Appl. No.: 09/992,530

(22) Filed: Nov. 6, 2001

Related U.S. Application Data
(60) Provisional application No. 60/255,733, filed on Dec. 14, 2000.

(51) Int. Cl. G02B 6/35

(52) U.S. Cl. 385/18

(57) ABSTRACT

An acoustic pulse is used to actuate the movable part of a MEMS device. The MEMS device generally comprises a substrate one or more movable elements coupled to the substrate and means for acoustic pulse actuation of at least one of the one or more movable elements. The MEMS device may be in the form of an optical switch having one or more mirrors rotatably attached to a substrate. Acoustic pulse actuation eliminates the need for magnetic pads and electromagnets along with the disadvantages associated with MEMS devices having these components. Furthermore, the acoustic pulse actuation may take place in a liquid environment, which reduces problems with stiction and improves the reliability of the device.

### CROSS-REFERENCE TO A RELATED APPLICATION

This application is based on and claims priority from Provisional application 60/255,733 filed Dec. 14, 2000, the entire disclosure of which is incorporated herein by reference.

### FIELD OF THE INVENTION

This invention relates generally to microelectromechanical systems (MEMS). More particularly, it relates to actuation of MEMS devices.

### BACKGROUND ART

Microelectromechanical systems (MEMS) are miniature mechanical devices manufactured using the techniques developed by the semiconductor industry for integrated circuit fabrication. Previous patents and publications have described fiber-optic switches that employ moveable micromirrors that move between two positions. Some of the prior art also employs electrostatic clamping of these mirrors at one or more of its two positions. For example, FIGS. 1 and 2 depict an optical crossbar switch 100 having a series of moveable mirrors 102 moveably coupled to a substrate 104. The mirrors 102 may be magnetically actuated as is known in the art. The mirrors 102 can be electrostatically clamped either in the horizontal position to the substrate 104 or in the vertical position to the sidewalls of a separate chip. In the vertical position, the mirrors 102 deflect light from an input fiber 106 into an output fiber 108. The mirrors 102 may be enclosed by a package 107.

The design, fabrication, and operation of magnetically actuated micromirrors with electrostatic clamping in dual positions for fiber-optic switching applications are described, for example in B. Behin, K. Lau, R. Muller Magnetically actuated micromirrors for fiber-optic switching, Solid-State and Actuator Workshop, Hilton Head Island, S.C., Jun. 8-11, 1998 (p. 273-276) which is incorporated herein by reference. Such mirrors, shown in FIGS. 1 and 2, are typically actuated by an off-chip electromagnet and can be individually addressed by electrostatic clamping either to the substrate surface or to the vertically etched sidewalls formed on a top-mounted (110)-silicon chip. The magnetic actuation is used to move the mirrors between their rest position parallel to the substrate and a position nearly parallel to the vertical sidewalls of the top-mounted chip. The mirror can be clamped in the horizontal or vertical position by application of an electrostatic field between the mirror and the substrate or vertical sidewall, respectively. The electrostatic field holds the mirror in that position regardless of whether the magnetic field is on or off.

This technology has many drawbacks:

1. For example, magnetic actuation often requires creating magnetic material pads 110 (pads) on the movable mirrors 102. This is usually achieved using a thick photoresist mask pattern and electroplating of a thick (about 10 um) magnetic layer through the photoresist mask. The pads 110 limit the area of the mirror 102 that is available for deflecting optical signals. p1 2. Magnetic actuation also often requires a quite bulky electromagnet 112 attached outside a device package. The electromagnet 112 increases the weight of the switch 100.

Operation of the electromagnet also consumes a significant amount of power.

3. The movable parts (e.g., mirrors 102) are usually connected to the substrate 104 or other support structure by a thin hinge. Thick magnetic pads created on the movable part (e.g., mirrors 102) increase the probability that the hinges will break during operation and handling of the switch 100.

4. Magnetic pads 110 placed on the movable part (mirror 102) consume surface area of the device, which decrease a level of integration (or scale of device).

Although non-magnetic mirror actuation systems have been developed, they have limited applicability. For example L. Ferreira, F. Pourlborz, P Ashar and C. Khan-Malek “Torsional Scanning Mirrors Actuated by Electromagnetic Induction and Acoustic Waves,” ICMP98—International Conference on Microelectronics and Packaging, which is incorporated herein by reference, describe a scanning mirror system wherein a torsionally mounted mirror is scanned using acoustic wave actuation. Unfortunately, the maximum mirror deflection possible with this system was less than 2° and this maximum deflection occurs only at a particular resonant frequency and falls off sharply for frequencies above and below the resonant frequency. Thus, the system does not provide enough mirror deflection or flexibility of operation to be useful in MEMS systems such as those depicted in FIGS. 1 and 2.

There is a need, therefore, for improved MEMS actuation that overcomes the above difficulties.

### SUMMARY

These disadvantage associated with the prior art are overcome by the present invention of using an acoustic pulse to actuate the movable part (e.g. a rotatable mirror) of a MEMS device. The MEMS device generally comprises a substrate one or more movable elements coupled to the substrate and means for acoustic pulse actuation of at least one of the one or more movable elements. The MEMS device may be in the form of an optical switch having one or more mirrors rotatably attached to a substrate. Acoustic pulse actuation eliminates the need for magnetic pads and electromagnets along with the disadvantages associated with MEMS devices having these components. Furthermore, the acoustic pulse actuation may take place in a liquid environment, which reduces problems with stiction and improves the reliability of the device.

### BRIEF DESCRIPTION OF THE FIGURES

FIG. 1 depicts an NXN MEMS optical crossbar switch according to the prior art;

FIG. 2 depicts a simplified cross-sectional schematic diagram of a MEMS optical switch with magnetic actuation according to the prior art;

FIG. 3 depicts a simplified cross-sectional schematic diagram of a MEMS device with acoustic pulse actuation from the backside in a gaseous environment according to an embodiment of the present invention; and

FIG. 4 depicts a simplified cross-sectional schematic diagram of a MEMS device with acoustic pulse actuation from the backside in a liquid environment according to an embodiment of the present invention.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention. Like reference numbers are used for like elements throughout.

FIG. 3 depicts an embodiment of a MEMS device 300 with acoustic pulse actuation and from a backside of a substrate. The device generally comprises a substrate 302 with one or more moveable elements 304, such as mirrors, mounted for rotation with respect to the substrate 302 between a horizontal position and a vertical position. The device 300 may include clamping mechanisms, such as electrostatic clamping electrodes, to selectively retain each moveable element 304 in the vertical or horizontal position. Each moveable element 304 may be mounted to the substrate 302 via one or more flexures that provide a torsional force that biases the moveable element 304 to return to the horizontal position in the absence of an actuating force or clamping force. Alternatively, the movable elements 304 may translate, e.g. vertically or horizontally. A package 306 that covers the movable elements 304 contains a gas (preferably nitrogen, although other inert gases will also work). Gas also fills a chamber 308 under the movable elements 304. Of course, the relative positions of the chamber 308 and package 306 may be reversed. The package 306 and chamber 308 are connected through holes 310 in the backside of the substrate 302 proximate the movable elements. An electromagnetic 312 is coupled to the chamber 308 to provide acoustic pulse actuation. In this embodiment the chamber 308 includes a membrane 309 that divides the chamber into two parts 311, 313. A first part 311 communicates with the package via the holes 310. A second part 313 is proximate to the electromagnet 312. Each part of the chamber 308 may be filled with the same medium, e.g. the same gas or liquid. Alternatively, the two parts 311, 313 may be filled with different media, e.g. different gases, different liquids, gas in one part liquid in the other part, or the first part 311 may be filled with gas or liquid and the second part 313 may be evacuated.

A pulse generator 314 coupled to the electromagnet 312 provides an electromagnetic pulse. Preferably, the membrane 309 is made of magnetic material in order to be able to interact with electromagnetic force produced by the pulsed magnetic field. The pulse of a magnetic field deforms the membrane 309, which creates acoustic pulse (medium pressure gradient) in the first part 311 of the chamber 308. This acoustic pulse propagates through the gas or liquid and actuates the movable elements 304, e.g., by turning one or more of the moveable elements 304 90 degrees around a hinge axis.

The magnitude of a given moveable element's angular movement depends on the maximal deformation of membrane 309, which controls local gas or liquid pressure gradient. The required amount of deformation can be obtained by properly choosing the elastic properties of the material of the membrane 309, the membrane's geometry and size, and the strength of the electromagnetic pulse. The magnitude of angular movement depends also on the moveable element's hinge stiffness and mass as well as the viscosity of the media in the chamber 308.

The pulse of magnetic field may be otherwise inductively coupled to the membrane 309, which delivers an acoustic pulse to the first part 311 of the chamber 308. In such case the membrane 309 may be dielectric, but could contain a coil, with electric current flowing through it, for interaction with the electromagnetic induction force. Such a coil can be deposited and patterned using photolithographic techniques.

Since to the membrane 309 need not oscillate, but just create a single deformation from the rest state, a short DC pulse (no frequency requirements). It is desirable to make the length of the pulse as short as possible to achieve the desired power or a given amount of membrane deflection.

The acoustic pulse is transmitted to the movable elements 304 though the holes 310 and drives one or more of the movable elements 304, e.g. causing it to rotate from a horizontal position towards a vertical position. Selected ones of the movable elements 304 may then be clamped in the vertical position by electrostatic clamping. In a similar fashion, specific movable elements 304 may be prevented from rotating, e.g. by electrostatically clamping them, e.g., against the substrate 302, in the horizontal position.

Other means for acoustic pulse actuation may be used in alternative embodiments of the present invention. For example, a piezoelectric transducer may be used place of the electromagnet and membrane of FIG. 3. Furthermore, a miniature piezoelectric transducer may be located proximate each of the holes to provide individual acoustic pulse actuation of each of the movable elements.

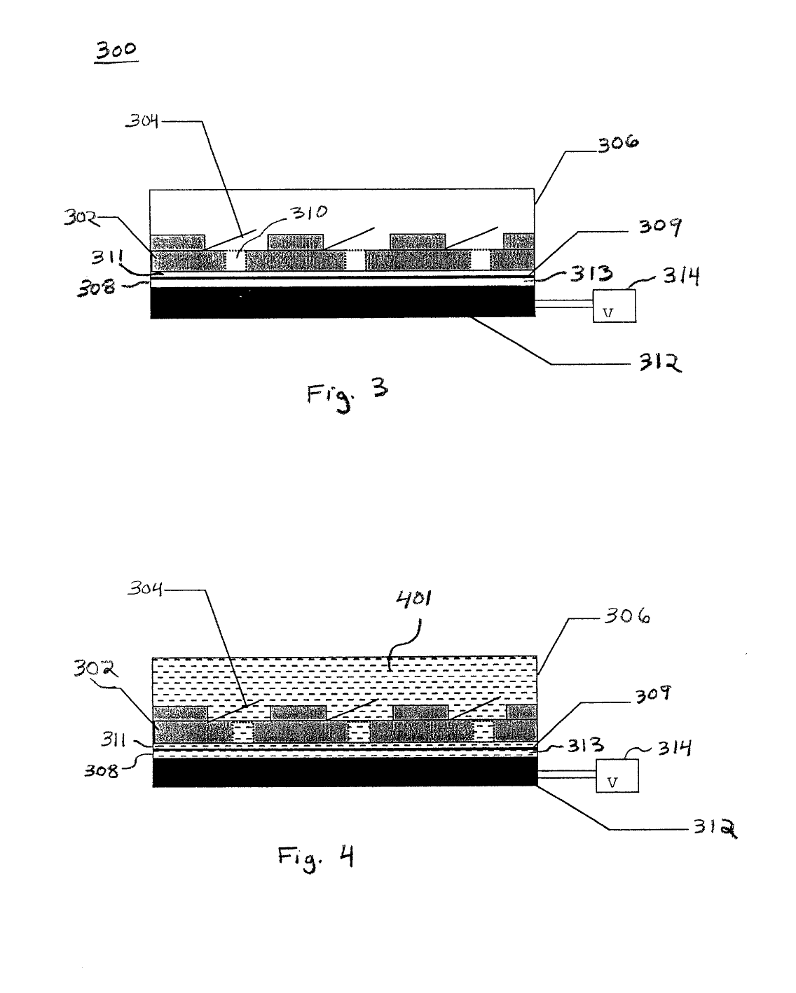

In an alternative embodiment, depicted in FIG. 4, the sound pulse may be delivered to the movable elements 304 through a liquid medium 401. Such a liquid medium is preferably transparent to sound waves in the wavelength range suitable for actuation of the movable elements.

Since embodiments of the device of the present invention operate with the single pulse of pressure (acoustic pulse), rather than a continuous acoustic wave, the acoustic transparency of the medium is immaterial, as long as the medium will transfer the energy. Other parameters, such as the speed of pulse propagation through medium and decay of energy, will differ from one material to another. From this point of view, liquids are better than gases. Liquid mediums will typically give shorter response time for the switch than gases.

For optical switch applications, it is desirable that the medium in the package 306, whether liquid or gas, be optically transparent to the wavelength of light for the optical switch operation, for example 1.3-1.5 micron.

Furthermore, it is desirable for the liquid medium 401 to have a low viscosity. The viscosity of the liquid medium 401 should be as low as possible. Suitable liquids include water and low viscosity oils will work if the electromagnet pulse is strong enough.

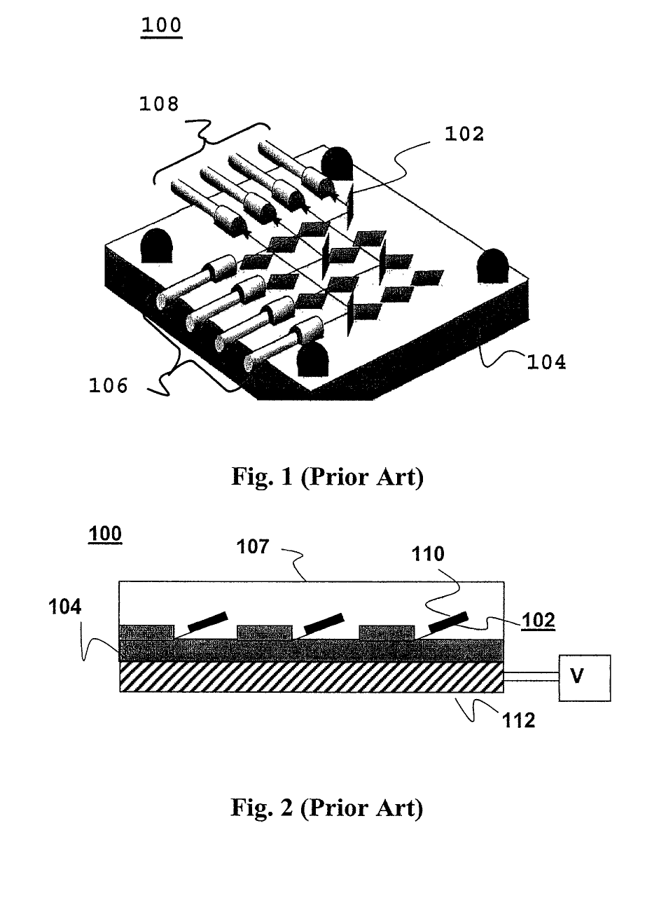

Any of the embodiments of pneumatic actuation means depicted in FIGS. 3-4 may be incorporated into a MEMS optical switch, such as an NXN crossbar switch of the type shown in FIG. 1. Such a switch typically includes a substrate and a plurality of rotatable mirrors, mounted for rotation with respect to the substrate. Advantages of such a MEMS optical switch with pneumatic actuation over similar switches with magnetic actuation are as follows:

1. The elements (mirrors) do not require a magnetic pad for actuation. The manufacturing is therefore simpler due to elimination of the electroplating process used to deposit the magnetic pads.

2. The size of the mirror elements may be made smaller and the scalability of the switch is enhanced since more elements may be incorporated onto the same footprint of the MEMS device due to elimination of the magnet pads.

3. Eliminating the heavy magnetic pads enhances the reliability of the switch due to reduced overall weight of the movable parts suspended on the hinges.

4. Absence of magnetic materials on a mirror makes optical switch insensitive to external electromagnetic fields.

5. Using acoustic pulse actuation in an inert gas environment improves reliability of the switch by eliminating external moisture penetration into the package, which can lead to stiction problems.

6. Using liquid environment eliminates stiction problems and improves the reliability of the switch.

In accordance with the foregoing, low-cost, high yield scalable MEMS devices and switches may be provided without the disadvantages attendant to magnetic actuation. It will be clear to one skilled in the art that the above embodiment may be altered in many ways without departing from the scope of the invention. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.”

What is claimed is:

1. A MEMS device comprising:
a) a substrate;
b) one or more movable elements coupled to the substrate for movement with respect to the substrate; and
c) means for acoustic pulse actuation of at least one of the one or more movable elements.

2. The device of claim 1 wherein the means for acoustic pulse actuation delivers an acoustic pulse to the one or more movable elements through one or more holes in a backside of the substrate.

3. The device of claim 1 wherein the means for acoustic pulse actuation delivers an acoustic pulse to a chamber below the substrate.

4. The device of claim 1, wherein the one or more movable elements are disposed in a liquid environment and the means for acoustic pulse actuation is in contact with the liquid environment, whereby the means for acoustic pulse actuation delivers the acoustic pulse to at least one of the movable elements through the liquid environment.

5. The device of claim 1 wherein the means for acoustic pulse actuation includes one or more MEMS pneumatic control valves.

6. The device of claim 1 wherein the means for acoustic pulse actuation includes a membrane inductively coupled to an electromagnet.

7. A MEMS optical switch, comprising:
a) a substrate;
b) one or more rotatable mirrors coupled for rotation with respect to the substrate; and
c) means for acoustic pulse actuation of the rotatable mirrors.

8. The optical switch of claim 7 wherein the means for acoustic pulse actuation delivers an acoustic pulse to the one or more movable elements through one or more holes in a backside of the substrate.

9. The optical switch of claim 7 wherein the means for acoustic pulse actuation delivers an acoustic pulse to a chamber below the substrate.

10. The optical switch of claim 7, wherein the one or more movable elements are disposed in a liquid environment and the means for acoustic pulse actuation is in contact with the liquid environment, whereby the means for acoustic pulse actuation delivers the acoustic pulse to at least one of the movable elements through the liquid environment.

11. The optical switch of claim 7 wherein the means for acoustic pulse actuation includes one or more MEMS pneumatic control valves.

12. The optical switch of claim 7 wherein the means for acoustic pulse actuation includes a membrane inductively coupled to an electromagnet.
